(19) United States
(12) Patent Application Publication
(10) Pub. No.: US 2009/0310484 A1
(43) Pub. Date: Dec. 17, 2009

(54) METHODS, SYSTEMS, AND COMPUTER READABLE MEDIA FOR SESSION INITIATION PROTOCOL (SIP) OVERLOAD CONTROL

(76) Inventors: Dorgham Sisalem, Berlin (DE); John Williams Floroiu, Berlin (DE); Mikkel Liisberg, Berlin (DE)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/425,998

(22) Filed: Apr. 17, 2009

Related U.S. Application Data
(60) Provisional application No. 61/045,836, filed on Apr. 17, 2008.

(51) Int. Cl. H04L 12/56; H04L 12/66

(52) U.S. Cl. 370/230; 370/352

(57) ABSTRACT

Methods, systems, and computer readable media for providing SIP overload control are disclosed. According to one method, a SIP server determines loading status of a resource of the SIP sever. The SIP server computes a rejection probability based on the loading status of the resource of the SIP server. The SIP server rejects received SIP messages based on the message types and the rejection probability.

### RELATED APPLICATIONS

This application claims the benefit of U.S. Provisional Patent Application Ser. No. 61/045,836, filed Apr. 17, 2008; the disclosure of which is incorporated herein by reference in its entirety.

### TECHNICAL FIELD

The subject matter described herein relates to reducing overload conditions in voice over Internet protocol (VoIP) networks. More particularly, the subject matter described herein relates to methods, systems, and computer readable media for SIP overload control.

### BACKGROUND

VoIP servers constitute the core components of any VoIP infrastructure. These servers are responsible for processing and routing VoIP signaling traffic and supporting various advanced services such as call forwarding or voicemail. In order to ensure a highly available VoIP service, these servers will have to continue performing their tasks even under high load situations. In the context of VoIP servers, overload indicates a shortage of crucial resources at the server such as memory or CPU. These overload situations can occur as the result of a denial of service attack or from software or hardware problems on the VoIP server itself. Work done in [1] suggests that overload situations not only reduce the performance of a SIP server but also can finally lead to a complete standstill of the complete VoIP service. To withstand sudden increases in traffic or temporary lack of resources, VoIP servers need to implement overload control mechanisms that aim at reducing the workload of these servers and prevent a complete depletion of their resources. In designing the overload control mechanisms for VoIP servers, the cause of the overload plays a major rule in deciding the system's reaction to the overload situation. On the one hand, when overload is caused for example by a denial of service attack, it would be useless to redirect the incoming traffic to another server, as this would only result in overloading that server as well. On the other hand, redirection would be an appropriate option when the overload situation is caused by software, hardware failures or unbalanced traffic load.

Currently, most VoIP services are based on the session initiation protocol (SIP), [2]. SIP, however, does not offer sufficient mechanisms for handling overload situations. Hence, there exists a need for methods, systems, and computer readable media for SIP overload control.

### SUMMARY

As described above, like any other Internet-based service, VoIP servers can get overloaded. This overload can result from a denial of service attack, flash crowd scenario or hardware and software problems on the VoIP server itself. Depending on the cause of the overload and the overloaded resource, different overload control mechanisms will have to be deployed. A new approach called the Receiver-based SIP Overload Control Algorithm (R-SOCA), which aims at stabilizing the behavior of a VoIP server during overload situations and preventing a complete service interruption, is described herein. R-SOCA is designed so that it takes the cause of the overload as well the nature of the overloaded resource into consideration. R-SOCA was implemented in a SIP proxy and tested under various conditions. The test results show a significant improvement in the performance of a SIP proxy under overload situations and the ability of this algorithm to stabilize the performance of SIP proxies even under a denial of service attack.

Methods, systems, and computer readable media for providing SIP overload control are disclosed. According to one method, a SIP server determines loading status of a resource of the SIP server. The SIP server computes a rejection probability based on the loading status of the resource of the SIP server.

According to another aspect, a system for providing overload control at a SIP server is provided. The SIP server receives and forwards SIP messages. A SIP overload control module is operatively associated with the SIP server. The SIP overload control module determines a loading status of a resource of the SIP server. The SIP overload control module computes a rejection probability based on the loading status of the resource of the SIP server. Incoming requests are rejected based on this probability and types of the received messages.

The subject matter described herein for providing SIP overload control may be implemented using a computer readable medium to having stored thereon executable instructions that when executed by the processor of a computer control the computer to perform steps. Exemplary computer readable media suitable for implementing the subject matter described herein includes disk memory devices, programmable logic devices, and application specific integrated circuits. In one implementation, the computer readable medium may include a memory accessible by a processor. The memory may include instructions executable by the processor for implementing any of the methods for SIP overload control described herein. In addition, a computer readable medium that implements the subject matter described herein may be distributed across multiple physical devices and/or computing platforms.

### BRIEF DESCRIPTION OF THE DRAWINGS

Preferred embodiments of the subject matter described herein will now be explained with reference to the accompanying drawings of which:

FIG. 1 is a graph illustrating CPU costs associated with dropping, forwarding, and rejecting incoming SIP requests according to an embodiment of the subject matter described herein;

FIG. 2A is a network diagram illustrating an exemplary test environment for testing a SIP overload control module according to an embodiment of the subject matter described herein;

FIG. 2B is a flow chart illustrating an exemplary method for controlling SIP overload at a SIP server according to an embodiment of the subject matter described herein;

FIG. 3 is a graph illustrating a relationship between received and accepted calls for linear traffic when using R-SOCA according to an embodiment of the subject matter described herein;

FIG. 4 is a graph illustrating a relationship between CPU utilization and rejection probability for linear traffic when using R-SOCA according to an embodiment of the subject matter described herein;

FIG. 5 is a graph illustrating a relationship between received and accepted calls for linear traffic when using SIP 503 messages according to an embodiment of the subject matter described herein;

FIG. 6 is a graph illustrating a relationship between CPU utilization and rejection probability for linear traffic when using SIP 503 messages according to an embodiment of the subject matter described herein;

FIG. 7 is a graph illustrating CPU utilization by R-SOCA under heavy load according to an embodiment of the subject matter described herein;

FIG. 8 is a graph illustrating processing behavior of R-SOCA under heavy load according to an embodiment of the subject matter described herein;

FIG. 9 is a graph illustrating performance of R-SOCA under a BYE DoS attack according to an embodiment of the subject matter described herein;

FIG. 10 is a graph illustrating performance of R-SOCA under a BYE DoS attack according to an embodiment of the subject matter described herein;

FIG. 11 is a graph illustrating performance of R-SOCA under a BYE and INVITE DoS attack according to an embodiment of the subject matter described herein;

FIG. 12 is a graph illustrating CPU performance of R-SOCA under a BYE and INVITE DoS attack according to an embodiment of the subject matter described herein;

FIG. 13 is a graph illustrating performance of using SIP 503 messages under a BYE and INVITE DoS attack according to an embodiment of the subject matter described herein;

FIG. 14 is a graph illustrating CPU performance of sending SIP 503 messages under a BYE and INVITE DoS attack according to an embodiment of the subject matter described herein;

FIG. 15 is a graph illustrating R-SOCA memory control according to an embodiment of the subject matter described herein;

FIG. 16 is a graph illustrating call throughput in the case of memory overload according to an embodiment of the subject matter described herein;

FIG. 17 is a graph illustrating R-SOCA memory control in the case of a flash crowd according to an embodiment of the subject matter described herein;

FIG. 18 is a graph illustrating call throughput in the case of memory overload and a flash crowd according to an embodiment of the subject matter described herein;

FIG. 19 is a graph illustrating R-SOCA memory control in the case of a flash crowd according to an embodiment of the subject matter described herein; and

FIG. 20 is a graph illustrating call throughput in the case of memory overload and a flash crowd according to an embodiment of the subject matter described herein.

### DETAILED DESCRIPTION

### I. Introduction and Motivation

A new overload control scheme designed to be used by SIP-based VoIP servers is described herein. The scheme called Receiver-based SIP Overload Control Algorithm (RSOCA) aims at reducing the load on VoIP servers by shedding traffic proportionally to the measured overload status. R-SOCA is designed so that it takes the cause of the overload as well the nature of the overloaded resource into consideration. RSOCA is designed to improve the performance of the SIP proxies without the need to standardize new features of SIP or to realize some cooperation or feedback between SIP proxies.

In Sec. II we take a brief look at possible causes of overload and the current status of congestion control for SIP. R-SOCA is then presented in Sec. III. To test the performance of RSOCA, R-SOCA was implemented as part of a SIP proxy. The test results are described in Sec. IV. In our performance investigation we investigate the capability of R-SOCA to stabilize the behavior of a SIP proxy under various traffic loads and models. Sec. V finally summarizes the subject matter described herein and describes the open issues that will need to be solved in future work. Note that the examples described herein relate primarily to SIP proxies. However, the proposed solution applies equally well to all other kinds of SIP components such as PSTN gateways, back-2-back user agents or softswitches. The term “SIP server” as used herein is intended to includes any type of SIP component that receives SIP signaling requests, including those described in this paragraph.

### II. Background and Related Work

In its simplest form a SIP-based VoIP service consists of user agents (UA), proxies and registrar servers. The UA can be the VoIP application used by the user, e.g., the VoIP phone or software application, a VoIP gateway which enables VoIP users to communicate with users in the public switched network (PSTN) or an application server, e.g., multi-party conferencing server or a voicemail server.

The registrar server maintains a location database that binds the users' VoIP addresses to their current IP addresses.

The proxy provides the routing logic of the VoIP service. When a proxy receives SIP requests from user agents or other proxies it also conducts service specific logic, such as checking the user's profile and whether the user is allowed to use the requested services. The proxy then either forwards the request to another proxy or to another user agent or rejects the request by sending a negative reply.

A SIP proxy acts in either stateful or stateless mode. In the stateful mode, the proxy forwards incoming requests to their destination and keeps state information about each forwarded request until either a reply is received for this request or a timer expires. If the proxy did not receive a reply after some time, it will resend the request. In the stateless mode, the proxy would forward the request without maintaining any state information. In this case the user agents would be responsible for retransmitting the request if no replies were received. As the stateful behavior reduces the load on the user agents and provides the service provider with greater session control possibilities, e.g., forwarding the request to another destination if the first one did not reply, stateful SIP proxies are usually used by VoIP providers.

With regard to SIP messages, we distinguish between requests and replies. A request indicates the user's wish to start a session (INVITE request) or terminate a session (BYE request). We further distinguish between session initiating requests and in-dialog requests. The INVITE request used to establish a session between two users is a session initiating request. The BYE sent for terminating this session would be an in-dialog request. Replies can either be final or provisional. Final replies can indicate that a request was successfully received and processed by the destination. Alternatively, a final reply can indicate that the request could not be processed by the destination or by some proxy in between or that the session could not be established for some reason. Provisional responses indicate that the session establishment is in progress, e.g., the destination phone is ringing but the user did not pickup the phone yet.

SIP proxies constitute the core components of a VoIP service and will have to handle signaling traffic arriving from thousands if not millions of user agents. The subject matter described herein therefore concentrates on providing a solution for handling congestion scenarios that might influence the behavior of SIP proxies.

From the brief description of SIP-based VoIP services, there are two main resources that might get overloaded at a SIP proxy, namely, CPU and memory. CPU resources are used for parsing incoming messages and executing service specific tasks which might include writing logging information, reading from a database or evaluating a user's profile for example. When acting in transaction stateful mode, memory will be consumed at the SIP proxy for maintaining various transaction state information related to the request. This memory will be dedicated for this transaction until either a final reply was received for this request or some timer expires. [2] specifies that a proxy is supposed to keep this state information for several seconds or even a few minutes depending on the exchanged requests and replies. Besides these two main resources, several other resources are essential to the proper working of a SIP proxy. Such resources include the number of free processes or threads in a multi-process implementation (see [3]); the number of busy ports; and disk space. Although the examples described herein relate primarily to reducing the overloading of memory and CPU resources, the subject matter described herein for SIP overload control can be applied to reduce the overloading of other resources of a SIP server, including those referenced in this paragraph.

CPU and memory can become overloaded at a SIP proxy due to various reasons such as:
Flash crowds: Flash crowd scenarios describe a sudden increase in the number of phone calls in the network. An example for this is when thousands of users want to vote on a TV show. This sudden increase in the number of calls will result in an increase in the required CPU and memory at the server.
Denial of service (DoS) attack: DoS attacks on a SIP proxy can take different forms and target either the memory consumption of the server or the CPU—or both [4].
   Flooding attacks: With these kinds of attacks, an attacker generates a large number of SIP requests. Even if these requests end up being dropped by the proxy, the proxy will first have to parse and process them before deciding to either forward, reject or drop them. Depending on the number of generated requests, such attacks can misuse a large portion of the CPU available to the proxy and reduce the amount of CPU available for processing valid requests.
   Memory attacks: This is a more intelligent kind of attack in which the attacker sends valid SIP requests that are forwarded by the proxy to destinations that do not answer properly. With each forwarded request, the proxy will maintain some transaction state. If the destination of these requests does not answer at all, then the proxy will continue to try for some time, 32 seconds, the so called Timer B in [2], before it can delete the state information. If the destination answers with a provisional response but not with a final response, then the proxy will have to keep the transaction state for at least 3 minutes, the so called Timer C in [2].
Unintended traffic: Software errors or configuration mistakes can cause one or more user agents or SIP proxies to send unintentionally multiples of the amount of the traffic they usually generate. Even though the excess traffic is not generated with malicious intent it is just as useless as DoS traffic and can just as well cause an overload situation.
Software errors: Software errors include memory leak problems or infinite loops. Memory leak would deplete the available memory in a similar manner as a memory DoS attack. An infinite loop could block the proxy from serving SIP requests.

The session initiation protocol (SIP) is specified in the RFC 3261 [2]. While this specification describes the behavior of a SIP proxy in general, it does not provide much guidance on how to react to overload conditions. [2] indicates that a server that is not capable of serving new requests, e.g., because it is overloaded, could reject incoming messages by sending a 503 (service unavailable) reply back to the sender of the request. Additionally, the 503 reply includes a retry after header which indicates to the sender of the request when it can try to resend the request to this server. This would signal the sender to try forwarding the rejected request to another proxy and not to use the overloaded proxy for the retry-after time. In case the overloaded server is contacted by a lot of users, then using different values of retry-after would ensure that the traffic arriving at the proxy would only increase gradually. However, in many deployment scenarios, a proxy is contacted only by a few other proxies or gateways. In this case using the 503 approach would result in a stop and go traffic behavior at the overloaded proxy, which would lead to an oscillative and unstable over all network behavior. Also, directing the traffic to other proxies would usually cause these proxies to become overloaded. Hence, using 503 is more likely to relieve the overloaded proxy only when it is facing a lot of user agents and in cases of internal errors, e.g., hardware or software problems, that would prevent the proxy from performing in the expected manner.

In [5] the author discusses the drawbacks of using the 503 reply for indicating overload and the requirements an overload control scheme should fulfill. Among these requirements is that an overload control scheme should enable a server to support a meaningful throughput under all circumstances, should prevent forwarding traffic to other servers that might be overloaded themselves and should work even if not all servers in the network support it.

Hilt describes in [6] an approach for handling overload based on having the overloaded proxy exchanging load information with its neighboring proxies. The neighboring proxies would then adjust the amount of traffic they send to the overloaded proxy based on this information. While this approach seems to be promising, no simulative or measured results are reported for this work. Further, this approach requires the definition of new headers and replies, making it usable mainly between proxies that implement this solution.

[7] describes an approach for avoiding overload by separating different types of SIP messages into different queues and allocating specific shares of the CPU to the different queues. This approach can help in preventing overload situations when for example the overload is caused by a certain type of messages. However, this approach does not help against memory attacks or flooding attacks that use different kinds of SIP requests. In a related manner, in [8] the author also discusses the possibility of using different queues to prioritize certain messages.

Similar to the above mentioned schemes, R-SOCA is also designed to prioritize certain traffic in case of overload. However, in addition, R-SOCA takes into consideration the causes of the overload, e.g., DoS attack or flash crowd, in its reaction to overload.

### III. Receiver-Based Sip Overload Control Algorithm (R-SOCA)

As discussed in Sec. II, a SIP proxy is said to be overloaded if one or more of its resources is having a value above some maximal or other user-defined limits. Going above these limits can destabilize the system and even lead to complete failure, see [9]. Hence, the goal of the present overload control scheme is to reduce the load on the resources. Reducing the load on the SIP proxy can be realized by either dropping incoming requests or rejecting them, e.g., sending back a 5xx reply. However, both options have their costs in terms of CPU usage as well. In both cases, the SIP proxy will have to receive the request and either drop it or generate a reply and send it back. FIG. 1 depicts the results of a simple measurement scenario in which a SIP proxy either forwards all received requests, rejects all received requests with a 500 reply or drops all received requests. The results depicted in FIG. 1 suggest that dropping incoming requests, consumes slightly less CPU at the SIP proxy than rejecting them. However, dropping packets in SIP has its negative side effects. A sender that does not receive a reply to one of its requests will resend this request for a number of times. Hence, dropping requests will actually lead to an increase in the number of arriving requests at the SIP proxy. Considering that dropping one request could result in the sending of 6 or more retransmissions of the request, and that the CPU resources required for rejecting a request are only 20% higher than for dropping a request, the dropping approach will actually be more costly in terms of CPU usage at the end. Further, a sender that does not get a reply to its requests is likely to search for another proxy and resend the request to that proxy. This will finally lead to overloading other proxies as well. Therefore, R-SOCA uses the rejection approach as the main approach for reducing the load on the SIP proxy.

From FIG. 1 we can also observe that the amount of resources used for forwarding requests is much higher than that for rejecting them. For conducting the measurement, INVITE messages were sent to a SIP proxy. INVITE messages that are successfully forwarded will be followed by at least another two requests, namely ACK and BYE. Thereby, rejecting an INVITE message will not only save the resources needed for processing the INVITE message itself but would also save the resources that would have been needed for processing other in-dialog requests as well.

Besides aiming at reducing the load on the overloaded resources, R-SOCA was designed with the following additional goals in mind:
1) Keep the amount of used resources at the SIP proxy at predictable levels.
2) While the stability of the SIP proxy is not endangered, aim at serving the engineered load. Engineered load (E) is defined as the number of requests the system should be able to deal with. This includes the number of session initiating INVITE messages (E_{I}), number of in-dialog requests (E_{D}), e.g., the requests that are exchanged as part of a dialog such as BYE and re-INVITE messages, number of REGISTER messages (E_{R}) and the number of out-of dialog messages such as INFO, OPTIONS or MESSAGE for example (E_{O}). The values for the engineered traffic are defined based on the experience of the manufacturer of the SIP proxy and the expected usage scenario.
3) Prioritize running sessions. This is based on the assumption that a user would be more annoyed if his call gets interrupted or can't be terminated and he has to pay more because his BYE request was rejected by the SIP proxy than if he could not make a call in the first place.
4) Identify traffic that might be part of a DoS attack and penalize it with a higher rate than other traffic.
5) A SIP proxy implementing R-SOCA will interoperate seamlessly with other SIP entities that have no knowledge of R-SOCA.

### A. Probabilistic Message Rejection

There are two main resources that need to be protected from getting overloaded: memory and CPU. R-SOCA defines for each resource (R), e.g., memory and CPU, two thresholds; a minor (Rₘᵢₙ) and a major threshold (Rₘₐₓ). Once the minor threshold is exceeded, R-SOCA starts gradually reducing the load on the SIP proxy by rejecting incoming requests with the rejection probability of P_{T}^{R}. Once the maximum threshold is exceeded, all incoming requests are rejected. The minimum threshold (Rₘᵢₙ) is set to the amount of resources required to serve the so-called engineered traffic (E). The engineered traffic, is the amount of calls a SIP proxy is expected to receive and process successfully under normal operational conditions, e.g., no DoS attacks or flash crowd scenarios. The maximum threshold (Rₘₐₓ) is set to the amount of resources required to handle some worst-case scenarios such as flash crowds.

The major characteristics of R-SOCA can be described as follows:
At fixed time intervals T the current load status R_{T} for each resource R is measured and its rejection probability (P_{T}^{R}) is determined.

$${P}_{T}^{R} = \{ \begin{matrix}0 & {R}_{T} \leq {R}_{min} \\ \frac{{R}_{T} - {R}_{min}}{{R}_{max} - {R}_{min}} & {R}_{min} < {R}_{T} < {R}_{max} \\ 1 & {R}_{T} \geq {R}_{max}\end{matrix} \qquad ( 1 )$$

The rejection probability to be used by the SIP proxy (P_{T}) is then determined as the maximum value of all P_{T}^{R}. To avoid rapid changes in the rejection probability, an averaged rejection probability (\hat{P}_{T}) is determined as a weighted moving average over time with

\hat{P}_{T}=P_{T-1}×(1−σ)+P_{T}×σ (2)
For smoothing, a rejection probability σ of 0.6 was used. This value proved after a couple of measurements as the best choice between rapid reaction to sudden changes in the traffic and smooth changes of the rejection value. As the rejection probabilities are determined as moving averages, they will not converge to 0 or 1. Hence, \hat{P}_{T} is used as follows:
   If \hat{P}ₜ≦0:05, then the system in not considered overloaded and no incoming requests will be rejected.
   With 0.05<\hat{P}ₜ, then the system is considered overloaded.
   If any P_{T}^{R} had a value of 1 then the system in considered severely overloaded and \hat{P}_{T} is set to 1.
when the system is in overload status, INVITE requests and out of dialog requests, such as REGISTER and MESSAGE, will be rejected with probability of \hat{P}_{T}. To ensure that emergency calls are processed even under overload situations, emergency requests should not be rejected. In-dialog requests are not rejected.
when the system is considered severely overloaded, e.g. \hat{P}_{T} set to 1, then all incoming requests will be rejected.

The rejection is achieved by sending a 500 reply including a retry-after header indicating that the user agent should resend the request after T_{retry} seconds. The 500 replies are sent in stateless manner. That is, no state information is maintained for them and the negative reply is not retransmitted if no ACK was received. In case the 500 reply is lost the sender would resend the INVITE request. In case the sender receives the 500 reply it will send an ACK request. As the proxy will not find an appropriate transaction state for the ACK it can just drop it.

### B. Denial of Service Protection

Now, it is naturally possible that a DoS attack would consist of sending large amounts of requests that look like in-dialog requests such as BYE messages for example. In such a case, the above-mentioned steps would not lead to a reduction of the overload. To accommodate this scenario, for each type of in-dialog requests, the number of such requests (D) is counted and compared to the expected number of requests of this type (Dₑₙ). Depending on the used traffic model, see [10], each type of requests will constitute a certain share of the overall requests. So for example if 1000 calls per second are being processed successfully, e.g., the INVITE messages are getting a positive reply from the destination, then we can expect to receive on the average also 1000 BYE requests per second. If more than the expected level of a certain type of requests was received, then this can be seen as an indication of a DoS attack and the requests arriving in excess of the expected traffic should be dropped. Hence, the approach of Sec. III-A is extended as follows:
During each measurement interval T, the number of arriving data packets (D) for each type of in-dialog requests is counted.

Each type of requests that exceeds its engineered value will be dropped with a probability of ((D−Dₑₙ)/D). Re-INVITE messages will be rejected instead of dropped with a 500 reply including a retry-after header indicating that the user agent should retry the re-invite after T_{retry} seconds.

Thereby, the rejection rate of the requests which are suspected to be part of a DoS attack will be set proportionally to the number of requests sent in excess of the engineered load. This rejection probability would, however, still allow the forwarding of the engineered load.

For the case of in-dialog messages, rejecting requests can often have negative side effects. In IMS [11], the session establishment requires the exchange of an INVITE plus a number of PRACK and UPDATE requests. In case the INVITE message was accepted but the PRACK or UPDATE requests were rejected then the session establishment would be prolonged by at least the value of the retry-after indicated in the 500 reply. Also, a user agent that has sent a BYE might not even wait for the duration of the retry-after time (T_{retry}) indicated in the 500 replies.

As dropped messages will be normally retransmitted, the retransmitted messages will have some chance of passing an overloaded server. That is, with the exponential retransmission approach used by SIP, see [2], a user agent would retransmit an in-dialog request up to 9 times before quitting the session.

The re-INVITE messages can be rejected, as the user agents have to maintain the transaction state anyway and delaying will in general not have a considerable negative effect on the user's session.

The probability that all retransmitted requests sent by a user agent get dropped can be determined as pⁿ with p being the drop or rejection probability at the proxy and n being the number of the retransmitted request. Hence, to ensure that the probability that at least one of the retransmitted requests pass through the overloaded server with a probability of Pₚₐₛₛ, p should be set in the following manner:

$$\begin{matrix}{p}^{n} < {p}_{pass} & ( 3 ) \\ p < \sqrt[n]{{P}_{pass}} & ( 4 )\end{matrix}$$

with n being set to 10.

Dₑₙ is set to different values depending on the type of the request. For requests that are sent only once in a dialog, such as BYE or UPDATE, Dₑₙ is set to the following value:

Dₑₙ=max(E_{I},I)×Bₑₙ (5)

with I as the average value of successful session initiating INVITE requests and Bₑₙ as a burstiness factor used to accommodate sudden bursts of traffic.

Re-invite messages occur more often during a session. In this case, Dₑₙ would be set to

Dₑₙ=max(E_{I},I)×Bₑₙ×N_{τ} (6)

with N_{τ} as the expected number of re-invite messages during a session and can be estimated as the average duration of a session divided by the session update timer, see [12]. The session update timer indicates the frequency with which reINVITE messages are sent. τ

### C. Burstiness Protection For CPU

On one hand, Internet traffic is rather bursty in nature, see [13]. On the other hand, resources such as CPU should only be measured as average values over some time intervals. Further, continuously calculating the rejection rate and updating the system behavior would require a considerable amount of resources. Hence, it is possible that in between two measurement points, a large burst of signaling packets arrives that would require more processing resources than are available to the system. To allow for bursts of traffic an internal traffic counter is used that counts the number of received requests. Once the number of received requests of one type of engineered traffic, e.g., E_{I}, E_{D}, E_{R}, E_{O} exceeds a certain threshold, Bₑₙ times the engineered traffic for that kind of requests with (Bₑₙ≦1) the excess traffic will be rejected. That is, if for example if during the measurement interval T more than (E_{I}×Bₑₙ) INVITE requests were received the proxy will start rejecting all incoming session initiating INVITE requests.

The CPU value is measured every T seconds. As the CPU values C_{T} oscillate, we use an averaged value of the CPU Ĉ_{T} that determined as

Ĉ_{T}=Ĉ_{T-1}×(1−σ)+C_{T}×σ (7)

For our measurements we used a σ value of 0.6.

### D. Memory Specific Overload Control Procedure

Besides CPU, memory constitutes the second critical resource that can become overloaded in a SIP proxy. When acting in transaction stateful mode, a SIP proxy needs to keep some state information describing on-going transactions for a certain period of time. If no protective measures are taken, then during an overload phase, all of the memory available to the proxy might be occupied. In such a case the proxy would no longer be able to serve new calls. The average period of time during which the transaction state information must be kept at the proxy depends on the type of the requests:
A session initiating INVITE transaction would generally last for a duration of T_{I}. This value includes a ringing period besides the processing delays at the traversed proxies and the round trip delay.
A REGISTER transaction usually lasts for a duration of T_{R}. This value includes two rounds of message exchanges which are caused by the authentication procedure and the delay at the registration server which includes the delay caused by the database lookup and the delay needed for conducting the authentication procedure.
As the other kinds of SIP transactions generally do not include user interaction or authentication delay, the transaction delay T_{O} consists mainly of the processing and transport delay.

Hence, the minimum amount of memory (Mₘᵢₙ) needed to support the engineered traffic can be determined as follows:

Mₘᵢₙ=S×(E_{I}×T_{I}+E_{D}×T_{D}+E_{R}×T_{R}) (8)

with S as the number of bytes used by a SIP proxy to keep the state information of a transaction.

The maximum threshold Mₘₐₓ is then set to

Mₘₐₓ=Mₘᵢₙ×B (9)

with B as a factor that allows us to accommodate cases of higher delays in the network or bursts of traffic and is (B>Bₑn).

As described in Sec. III-A, while the value of the used memory is between Mₘᵢₙ and Mₘₐₓ the proxy would start rejecting incoming requests, i.e., session initiating INVITE, REGISTER and out of dialog requests, in a probabilistic manner.

A simple denial of service attack can be realized by sending SIP requests to destinations that do not reply. This would cause the SIP proxy to start retransmitting the requests and would prolong the duration over which the proxy needs to keep the transaction state information considerably. Actually, non-INVITE transactions would reside at the proxy for 32 seconds, INVITE transactions might have to be kept at the proxy for several minutes. Such an attack would deplete the memory resources at the proxy and would prevent it from serving the engineered traffic. The probabilistic rejection approach would not be sufficient by itself, as the memory depletion is not caused by a high call arrival rate but due to the excessive transaction delays. To accommodate this case, once the consumed memory value reaches Mₘᵢₙ, all active transactions will be continuously checked and
All session initiating INVITE transactions that are older then T_{I}×B are then terminated and the sender of the request is sent a 500 reply.
All in-dialog transactions that are older then T_{O}×B are terminated. No replies are sent to the originator of the request. Thereby, if the request has not originated from a malicious user, the request would be retransmitted and would still have a chance of reaching its destination.
All REGISTER transactions that are not destined to the proxy and are older then T_{R}×B are terminated and the originator of the request is sent a 500 reply.
All other requests that are older then T_{O}×B are terminated and the originator of the request is sent a 500 reply.

While terminating a transaction prematurely deviates from the specifications of SIP, see [2], this approach prevents the depletion of the memory and enables the proxy to continue serving non-malicious traffic, e.g., requests that are answered by the end destinations in the average response times multiplied by B.

### IV. Performance Evaluation

In this section we test the performance of R-SOCA under different traffic conditions.

### A. Test Environment

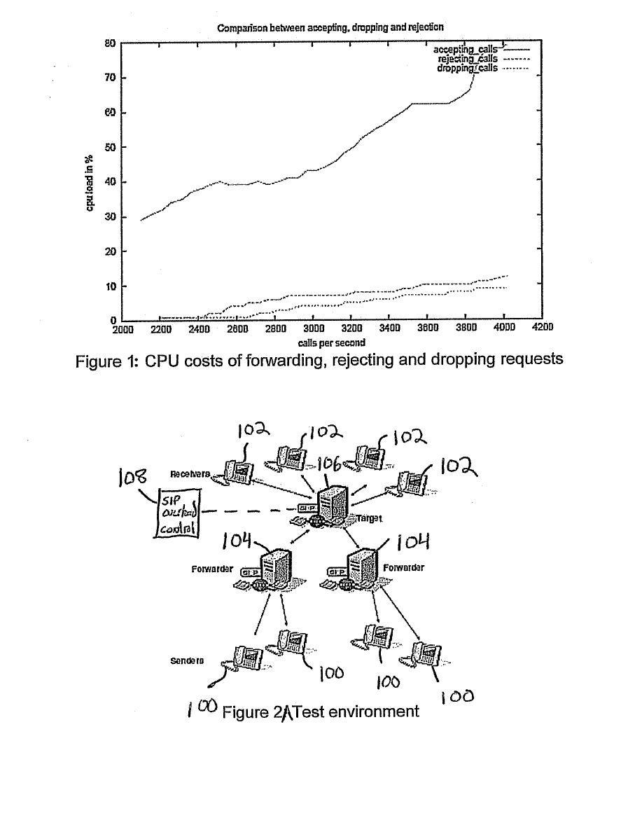

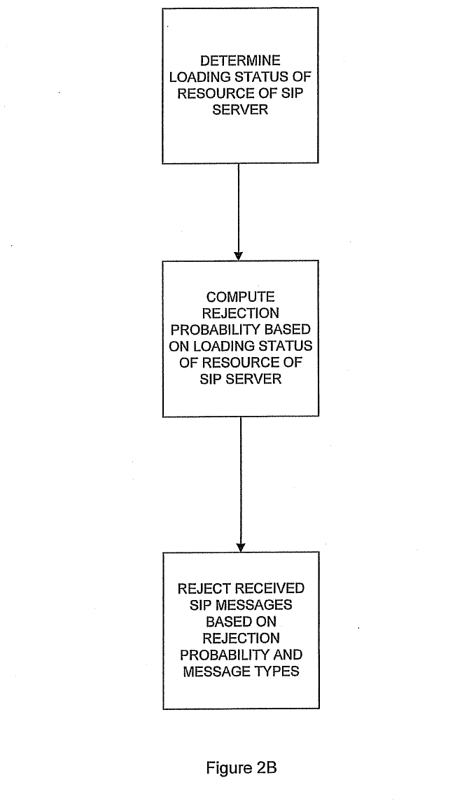

To test the performance of R-SOCA we extended a SIP proxy with the required logic. In the experiments described herein, an extended version of the SIP Express Router available from www.iptel.org was used. The test bed itself consists of a number of senders initiating calls to a number of receivers through. The SIP requests are sent from the senders to two forwarding SIP proxies which then forward the traffic to the target SIP proxy. The SIP proxies are connected to the network over a gigabit link, see FIG. 2A. In FIG. 2A, a plurality of SIP senders 100 send SIP messages to a plurality of receivers 102 via forwarders 104 and target 106. SIP senders 100 and receivers 102 may be SIP enabled phones, i.e., phones with SIP user agent client software loaded thereon. Forwarders 104 and target 106 may each be SIP servers, such as SIP proxy servers. According to an embodiment of the subject matter described herein, target 106 may include a SIP overload control module 108 that implements the steps described herein for SIP overload control.

FIG. 2B is flow chart illustrating exemplary overall steps for performing SIP overload control according to an embodiment of the subject matter described herein. The steps illustrated in FIG. 2B may be performed by SIP overload control module 108. Referring to FIG. 2B, in step 200, a SIP server determines a loading status of a resource of the SIP server. The resource may be CPU, memory, disk storage, network bandwidth, or any combination thereof. The loading status of the resource may be determined by querying or obtaining the information from the operating system, as most operating systems report metrics, such as CPU, memory, and disk utilization in real time. Alternatively, the loading status may be determined by an application separate from the operating system that monitors the loading status of the underlying resource. In step 202, a probability is computed based on the loading status of the resource. In one example, the probability is a message rejection probability. The message rejection probability may be computed using any of the probability equations set forth herein. The term, “rejection probability,” as used herein, refers to any probability that can be used to control the disposition of a received SIP message, including a probability that indicates a likelihood that a received SIP message should be accepted and a probability that indicates a likelihood that a received SIP message should be rejected. In step 204, received SIP messages are rejected based on the rejection probability and the message types. In one example, SIP overload control module 108 may reject SIP INVITE messages and other out of dialog request messages with a probability that is based on the computed probability.

In the experimental setup illustrated in FIG. 2A, the senders and receivers are emulated using the SIPP tool, which is an open source traffic generation available at http://sipp.sourseforge.net. To be able to test R-SOCA the target SIP proxy was extended with the following features:
Measure the CPU load each T seconds
Continuously measure the memory used by the proxy
Count the amount of each type of incoming requests (D)
Execute the R-SOCA logic, e.g., determine the rejection probability (\hat{P}_{T}) and the drop and rejection probability of in-dialog messages
Probabilistically reject or drop incoming requests if required so by R-SOCA. When there is the need to decide if a request is to be forwarded or rejected a random number between 0 and 1 is generated. If this number is lower than the rejection probability then the request is rejected.
   The proxy was configured to support an engineered load (E_{I}) of 2000 calls per second. The burstiness factor (Bₑₙ) was set to 1.7.

### B. CPU Performance Evaluation of R-SOCA

The minimum threshold (Cₘᵢₙ) was set to 20% of the available CPU. This was determined by measuring the CPU needed for handling the engineered traffic. The maximum threshold (Cₘₐₓ) was set to 40%.

a) Performance of R-SOCA under Flash Crowd and DoS Scenarios: In this test, the performance of R-SOCA is tested when the proxy faces an increasing number of session initiating INVITE requests. This can be due either to a flash crowd scenario or an attacker generating large numbers of session initiating INVITEs.

The arrival rate of the requests at the proxy is increased in a linear manner up to a maximum of 5000 calls per second and then is reduced again to the level of the engineered load (E_{I}).

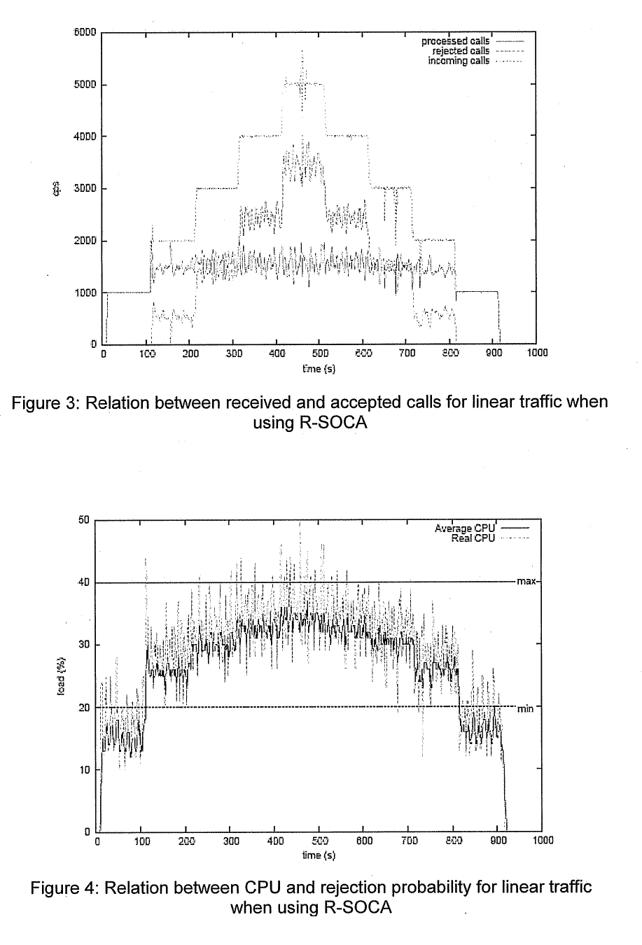

FIG. 3 shows that even though the amount of incoming calls is increasing the SIP proxy is still capable of serving at least the engineered load (E_{I}=1000). The CPU usage depicted in FIG. 4 shows that the CPU usage is bounded by the maximum and minimum thresholds.

The same test was repeated with the target proxy using an overload control mechanism based on sending a 503 reply when the CPU load exceeds the maximum threshold (Cₘₐₓ).

The 503 replies include a retry-after with a value that is randomly chosen between 1 and 3 seconds. As for the case of R-SOCA the CPU load was determined as a weighted moving average.

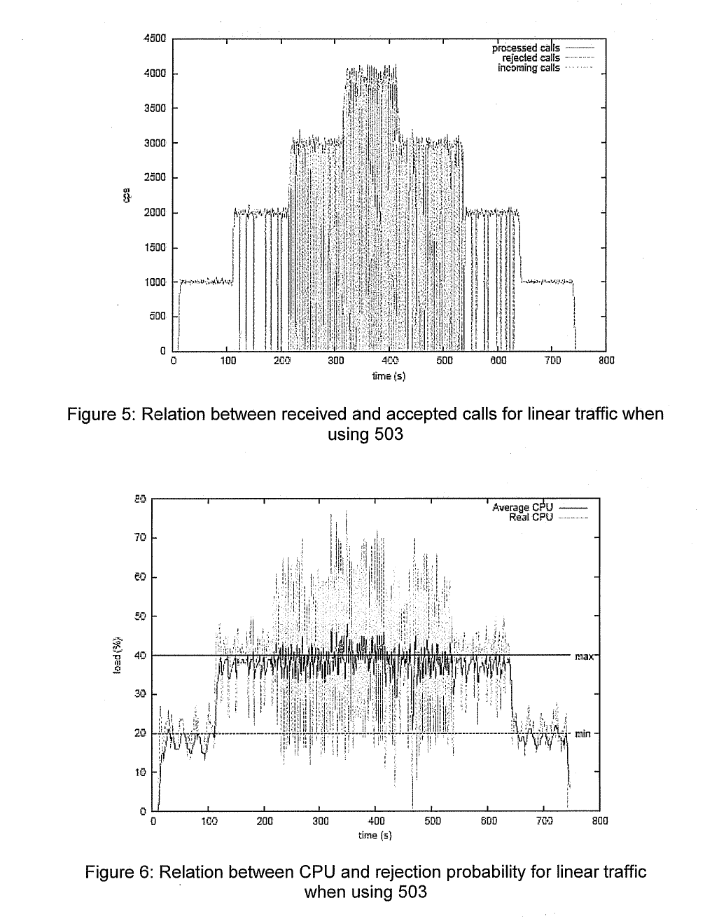

FIG. 5 depicts the relation between the incoming and accepted calls. Especially in the phase of a high number of calls, the 503 based overload control schemes can achieve a better throughput in terms of accepted number of calls than R-SOCA. This stems from the different goals and control strategies deployed by the two approaches. The goal of RSOCA is to keep the resource usage in predictable ranges. The 503 approach aims at using all the possible resources for serving the incoming requests. Therefore, with R-SOCA the average CPU usage is in general below the maximum threshold and the actual one exceeds the maximum threshold only rarely. FIG. 6 depicts that when using 503 for overload control the average CPU usage regularly exceeds the maximum threshold and the actual value is often much higher. This not only leads to the oscillative behavior of the system but can also lead to instability as these CPU usage peaks can temporarily block other processes on the system.

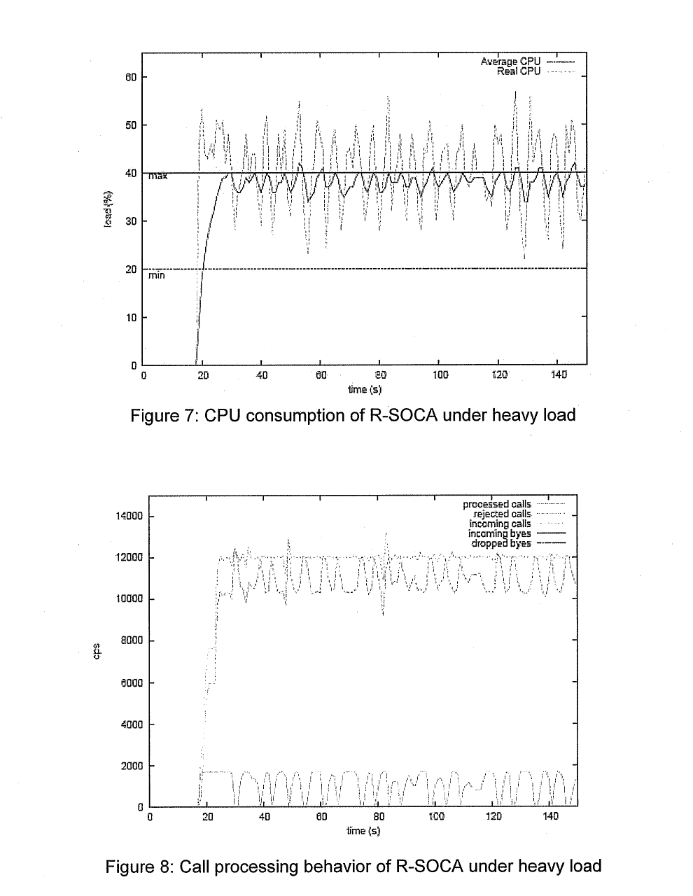

b) Performance of R-SOCA under Heavy Load: In this scenario the performance of R-SOCA is tested when subjected to an incoming call rate of around 10000 session initiating INVITE requests per second which is much higher than the supported engineered load (E_{I}=1000). Actually the amount of received traffic results in exceeding both the minimum and maximum thresholds. As seen in FIG. 7 R-SOCA manages to keep the CPU load around the maximum threshold (Cₘₐₓ). From FIG. 8 we can observe that the CPU load is distributed between processing and rejection of the incoming calls. On the average around 1500 calls per second are still successfully processed and maximally 1700 which is the maximum accepted burstiness level.

c) Performance of R-SOCA under BYE DoS Attacks: In the previous tests DoS attacks were initiated by sending a large

TABLE 1
Overall Performance of R-SOCA Under BYE DoS Attack

| Sent Invites | Successful calls | Successful termination |
|---|---|---|
| 196911 | 161193 | 150150 |

number of INVITEs. In the scenario tested here, the emulated DoS attack consists of a sender sending a constant load of 12000 BYE messages per second. With the DoS protection mechanism of R-SOCA, BYE requests that arrive in excess of the expected values are dropped. With an engineered traffic of 1000 calls per second and the burstiness factor set to 1.7, the expected number of BYEs would be 1700. In general a dropped BYE would be retransmitted by the user agent. However, as it is simpler for an attacker to generate multiple BYE requests instead of keeping a state machine that would be needed for conducting the SIP retransmission behavior, it is assumed here that an attacker will not retransmit a dropped BYE.

Further, Pₚₐₛₛ was set to 10%, which results in a maximal allowed drop rate of 79.5%. Thereby, only 10% of the sent BYE transactions will not be able to terminate successfully.

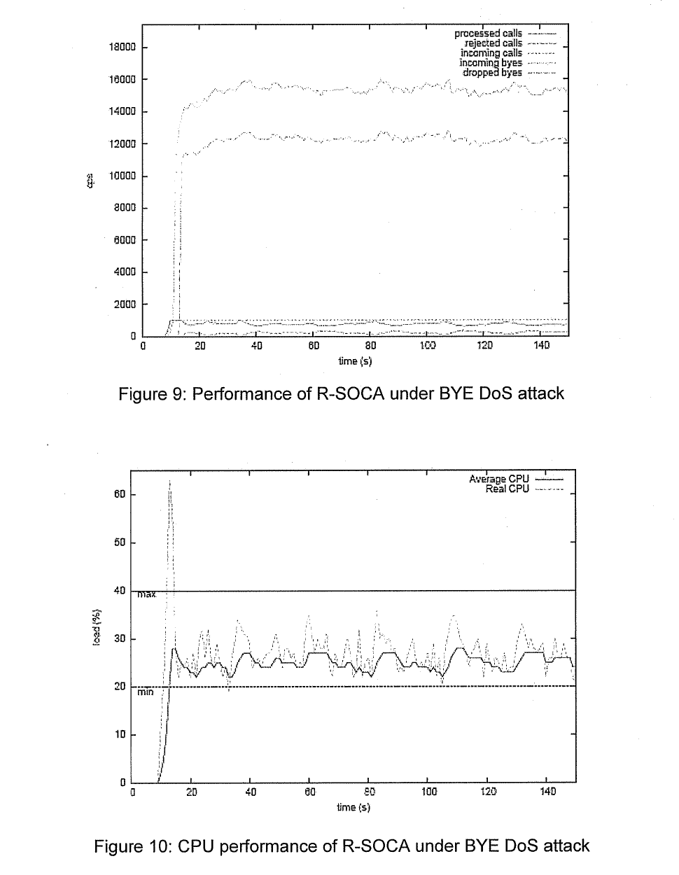

FIG. 9 depicts the behavior of the proxy when it is receiving 12000 BYE messages and 1000 INVITE requests per second. The DoS protection mechanism will result in dropping BYE requests both from the attacker as well as from legitimate users. The dropped BYE requests which were sent by legitimate users are retransmitted leading to an overall rate of incoming BYE requests of around 18000 BYEs per second. From FIG. 10 we can observe that even under this heavy load of incoming messages, the overall CPU rate is at around 23%, which is only minimally higher than the used Cₘᵢₙ.

Table 1 summarizes the results of the measurement. Out of nearly 200000 initiated calls around 15% of the calls were rejected. Out of the successful calls 94% were successfully terminated. 6% of the calls could not be terminated successfully as the sent BYE requests and their retransmissions were dropped by the overloaded proxy. Note that by increasing the value of the maximally expected BYE requests or using a smaller pₚₐₛₛ values would reduce the number of unsuccessful terminations. However, this would mean that a larger number of malicious BYE requests are processed by the proxy and hence would lead to a higher CPU usage, which would then increase the call rejection rate.

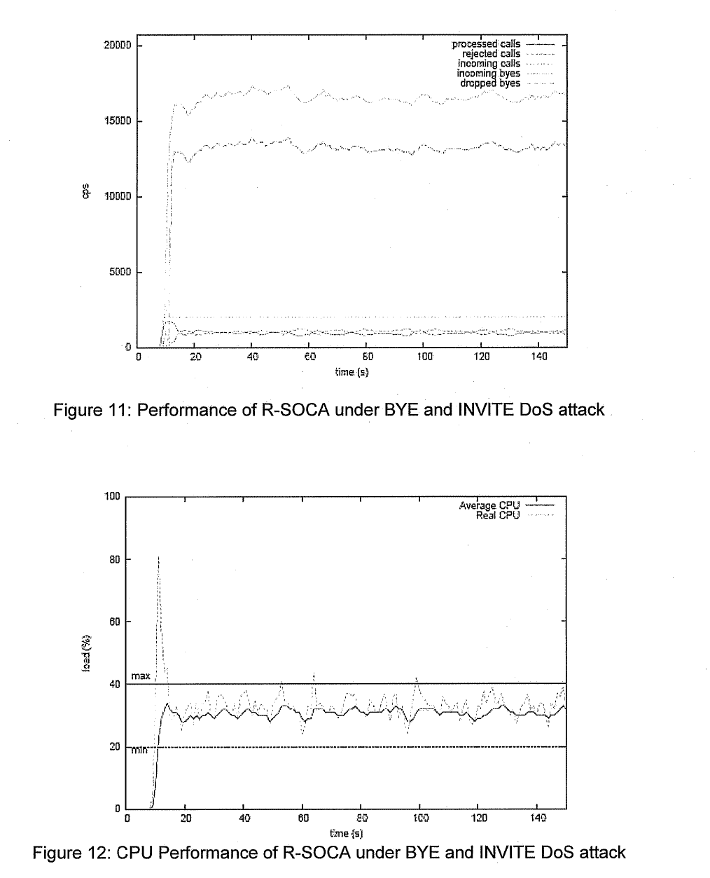

FIG. 11 depicts the behavior of the proxy when it is receiving 12000 BYE messages and 2000 INVITE requests per second, e.g. double the engineered traffic. We can observe that the proxy in this case will allow for the engineered traffic to pass through. From FIG. 12 we can observe that even under this heavy load of incoming messages, the overall CPU rate is at around 30%, which is between the thresholds used for controlling the CPU usage.

Table 2 summarizes the results of this measurement. Out of nearly 330000 initiated calls around 50% of the calls were rejected. Out of the successful calls 92% were successfully terminated. 8% of the calls could not be terminated successfully as the sent BYE requests and their retransmissions were dropped by the overloaded proxy.

The same attack was launched on a server using 503 replies for indicating overload. In this scenario 12000 BYE and 1000

TABLE 2
Overall Performance of R-SOCA Under BYE and INVITE DoS Attack

| Sent Invites | Successful calls | Successful termination |
|---|---|---|
| 363662 | 184290 | 168857 |

INVITE requests per second were sent to the targeted server. Once the CPU load of the server exceeds the maximum threshold (Cₘax) the proxy replies with a 503 to the incoming INVITE requests. Upon that, the forwarding proxies stop sending any new requests to the server for the retry-after period.

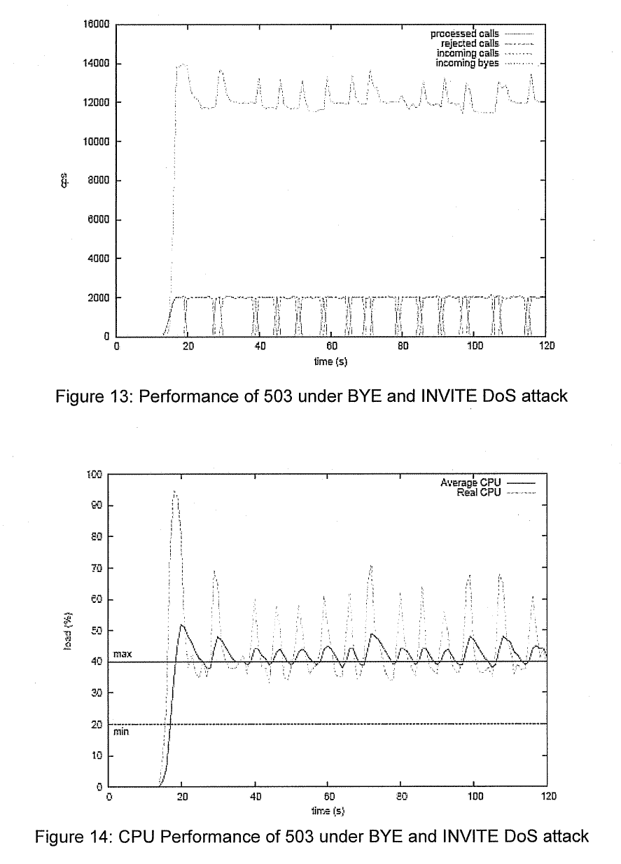

The results depicted in FIG. 13 and Table 3 suggest that only around 5% of the initiated calls are successful. From FIG. 14 it can be observed that the CPU load is nearly constantly around the maximum threshold which is caused by the high number of the BYE requests. Hence, while using 503 as the basis for overload control might be sufficient for dealing with a high number of incoming INVITE requests, further mechanisms are needed for handling of DoS attacks.

### C. Memory Control Performance of R-SOCA

With each received request, a stateful SIP proxy maintains some transaction state until the transaction is terminated. A simple yet effective DoS attack would consist of sending a lot of requests that are not answered. This can be realized by manipulating a receiver or creating a fake SIP account and bounding some address to it on top of which no SIP software is

TABLE 3
Overall Performance of 503 Under BYE and INVITE DoS Attack

| Sent Invites | Successful calls | Successful termination |
|---|---|---|
| 278938 | 46763 | 46763 |

running. In this case the SIP proxy will retransmit the request a number of times before timing out the transaction.

In this section the behavior of R-SOCA is tested in the case overload is caused by high memory consumption. The used SIP proxy consumes around 8.5 KBytes per transaction and the used average call establishment time (T_{I}) is set to 10 seconds and the engineered traffic is set to 1000 calls per second. This results in a minimal threshold (Mₘᵢₙ) of 85 MBytes and with the maximum allowed transaction duration set to 20 seconds, e.g., B=2, the maximum threshold (Mₘₐₓ) is set to 170 MBytes.

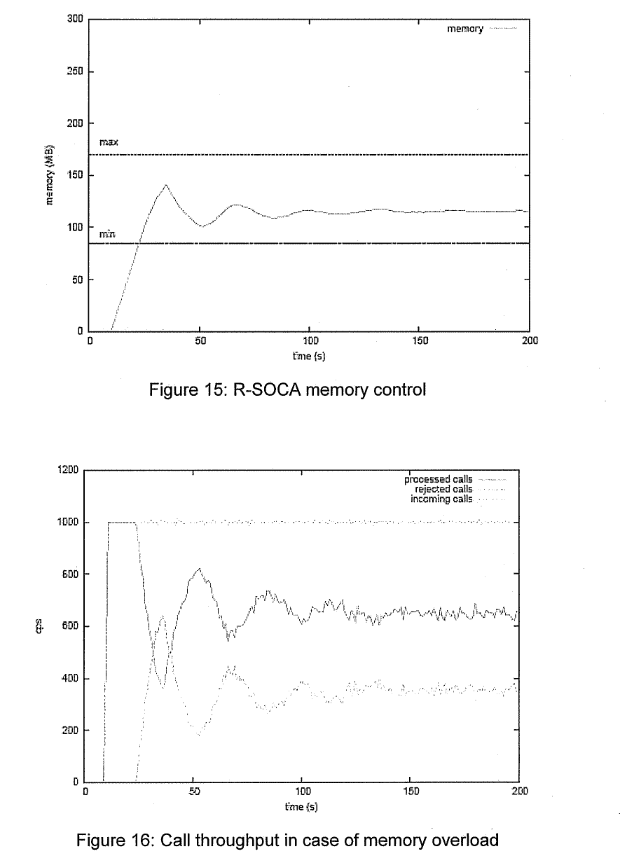

FIG. 15 shows the memory consumption of the SIP proxy for the case when the proxy is receiving 1000 calls per second. The INVITE requests are addressed to receivers that do not reply. The figure shows that the memory consumption increases over time. After passing the minimum threshold (Mₘᵢₙ) the proxy starts rejecting calls and once the maximum transaction time expires, e.g. 20 seconds, the proxy will start releasing memory and the memory consumption stabilizes at a level that is between the maximum and minimum thresholds. The number of calls stabilizes at around 720 calls per second, see FIG. 16. Thereby, the combination of call rejection and transaction termination manages to keep the memory at predictable levels.

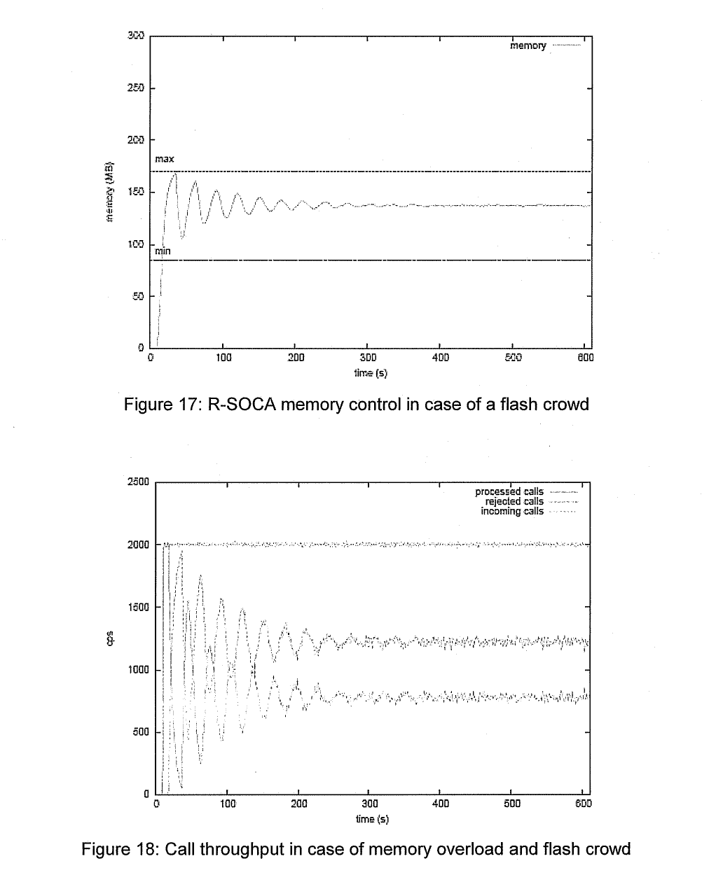

FIGS. 17 and 18 depict the performance of the system under a higher load of incoming calls, namely 2000 calls per second. As previously the calls are destined to receivers that do not answer. From the figures we can observe that with R-SOCA the memory usage is still bounded between the maximum and minimum thresholds. The call throughput is around 780 calls per second.

To test the behavior of a system that uses 503 for regulating overload status the previously run tests were repeated with the target proxy rejecting calls with a 503 reply as soon as the memory reaches the Mₘₐₓ. The retry-after value was set to 1 second. Further, the proxy terminates transactions that are older than then the maximum transaction time which was set here to 20 seconds. The incoming call rate was set to 2000 calls per second.

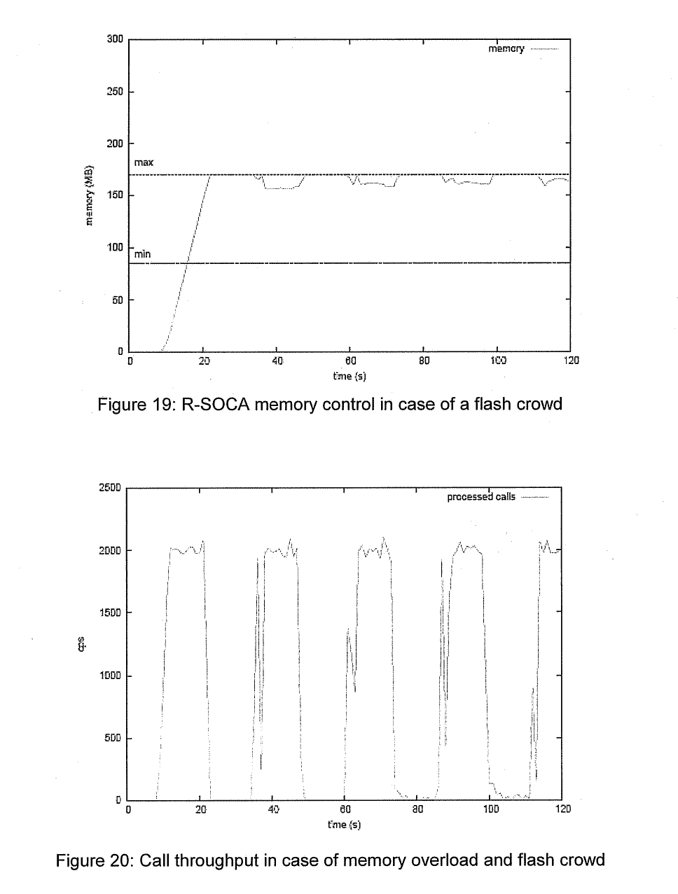

From FIGS. 19 and 20, we can observe that the system shows a rather oscillative behavior with the periods of high call throughput and then periods of call rejection. The memory is nearly constantly at Mₘₐₓ. While the average rate—around 920 calls per second—is higher than with R-SOCA, the overall behavior is a top and go manner with periods of call acceptance and then call rejection. Also the memory is used all of the time at the maximum possible value.

### V. Summary, Enhancements, and Future Work

A novel scheme for dealing with overload situations in SIP proxies is described herein. The measurement results suggest that R-SOCA can achieve its goals and enable an overloaded SIP proxy to continue serving SIP traffic under high overload situations and denial of service attacks and still keep the resource usage at a pre-defined and expected level.

Compared to the basis mechanism of SIP, e.g., sending a 503 reply when in overload status, R-SOCA achieves a more predictable and stable behavior. While with 503 it is possible to achieve a higher throughput in some scenarios, this is only achieved at the cost of higher resource usage and a more oscillative behavior.

While already offering very promising results, R-SOCA can be extended to support additional features especially in the area of dynamic parameter setting. Currently, the thresholds used for determining the overload status of the SIP proxy are pre-defined and are set based on measurement of the system. Detecting and setting these thresholds dynamically would enhance the efficiency of R-SOCA and reduce the configuration overhead. Measuring the distribution of request types and setting the expected values for each request type dynamically, would further improve the DoS detection and enable R-SOCA to react faster to such attacks. For example, SIP overload control module 108 may be configured to dynamically set, based on measured SIP message type distributions, the thresholds used to control the rejecting of messages and the computation of the probabilities described herein.

Finally, besides optimizing the schemes, future work will investigate the performance of R-SOCA in real-live environments and under different usage scenarios.

The disclosure of each of the following references is hereby incorporated herein by reference in its entirety.

### REFERENCES

[1] M. Ohta, “Simulation study of sip signaling in an overload condition.” In Communications, Internet, and Information Technology, M. H. Hamza, Ed. IASTED/ACTA Press, 2004, pp. 321-326.
[2] J. Rosenberg, H. Schulzrinne, G. Camarillo, A. Johnston, J. Peterson, R. Sparks, M. Handley, and E. Schooler, “SIP: Session Initiation Protocol,” RFC 3261 (Proposed Standard), June 2002, updated by RFCs 3265, 3853, 4320, 4916. [Online]. Available: http://www.ietf.org/rfc/rfc3261.txt.
[3] G. Zhang, S. Ehlert, T. Magedanz, and D. Sisalem, “Denial of service attack and prevention on sip VoIP infrastructures using DNS,” in Principles, Systems and Applications of IP Telecommunications (IPTCOMM), NY, USA, July 2007.
[4] J. Kuthan, S. Ehlert, and D. Sisalem, “Denial of service attacks targeting a SIP VoIP infrastructure—attack scenarios and prevention mechanisms,” 'IEEE Networks Magazine, vol. 20, no. 5, September 2006.
[5] J. Rosenberg, “Requirements for management of overload in the session initiation protocol,” Internet Engineering Task Force, Internet Draft, October 2006, work in progress.
[6] V. Hilt, I. Widjaja, D. Malas, and H. Schulzrinne, “Session initiation protocol (sip) overload control,” Internet Engineering Task Force, Internet Draft, March 2007, work in progress.
[7] A. Acharya, D. Kandlur, and P. Pradhan, “Differentiated handling of SIP messages for VoIP call control,” United States Patent 20050105464, May 2005.
[8] M. Ohta, “Overload protection in a sip signaling network,” in International Conference on Internet Surveillance and Protection (ICISP '06), 2006.
[9] E. Nahum, J. Tracey, and C. Wright, “Evaluating SIP server performance,” IBM T. J. Watson Research Center, Research report RC24183, February 2007.
[10] H. Schulzrinne, S. Narayanan, J. Lennox, and M. Doyle, “Sipstone—benchmarking sip server performance,” April 2002.
[11] “Signalling flows for the ip multimedia call control based on session initiation protocol (sip) and session description protocol (sdp),” 3^{rd} Generation Partnership Project, Technical Specification Group Core Network and Terminals, 2007.
[12] S. Donovan and J. Rosenberg, “Session Timers in the Session Initiation Protocol (SIP),” RFC 4028 (Proposed Standard), April 2005.
[13] M. Grossglauser and J.-C. Bolot, “On the relevance of long-range dependence in network traffic,” IEEE/ACM Transactions on Networking, vol. 7, no. 5, pp. 629-640, 1999. [Online]. Available: citeseer.ist.psu.edu/article/grossglauser96relevance.html.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for providing overload control at a session initiation protocol (SIP) server, the method comprising:
at a SIP server:
determining a loading status of a resource of the SIP server
computing a rejection probability based on the loading status of the resource of the SIP server; and
rejecting received SIP messages based on the type of the messages and the rejection probability.

2. The method of claim 1 wherein determining a loading status of a resource includes determining a loading status of one of: memory, processing resources, internal network bandwidth, storage resources, processes or threads, and ports of the SIP server.

3. The method of claim 1 wherein computing the message rejection probability includes computing the probability in accordance with the following equation:
$${P}_{T}^{R} = \{ \begin{matrix}0 & {R}_{T} \leq {R}_{min} \\ \frac{{R}_{T} - {R}_{min}}{{R}_{max} - {R}_{min}} & {R}_{min} < {R}_{T} < {R}_{max} \\ 1 & {R}_{T} \geq {R}_{max}\end{matrix}$$
, where R_{T} is the loading status of the resource for a time interval T, Rₘᵢₙ is a first loading status threshold set based on an engineered traffic load of the SIP server, and Rₘₐₓ is a maximum loading status of the resource.

4. The method of claim 1 comprising setting a loading status threshold dynamically based on a measured SIP message distribution and using the loading status threshold to control the rejecting of the SIP messages.

5. The method of claim 1 wherein rejecting received SIP messages includes rejecting INVITE messages and out-of-dialog requests while allowing processing of in-dialog SIP messages.

6. The method of claim 1 wherein the rejection probability comprises a weighted moving average of instantaneous SIP rejection probabilities computed based on the loading status of the resource at different times.

7. The method of claim 1 wherein rejecting the SIP messages includes sending SIP replies to senders of the rejected SIP requests.

8. The method of claim 7 wherein the SIP replies are sent without storing state information for the SIP replies at the SIP server.

9. The method of claim 7 wherein the SIP responses each include a retry-after header indicating that the senders should retry sending the rejected SIP requests after a specified time period.

10. The method of claim 1 comprising counting in-dialog SIP messages that arrive at the SIP server within a time interval, computing a denial of service (DoS) protection rejection probability for each in-dialog SIP message for which the count exceeds an engineered value and rejecting or discarding the in-dialog SIP messages for which the count exceeds its respective engineered value messages in accordance with the DoS protection rejection probability.

11. The method of claim 10 wherein counting in-dialog messages comprises maintaining separate counts for different types of in-dialog SIP messages and wherein computing the DoS protection rejection probability includes computing separate DoS protection rejection probabilities for each type of the in-dialog SIP messages for which the count exceeds an engineered value for the respective in-dialog SIP message type.

12. The method of claim 1 comprising determining whether a number of the received SIP messages of a certain type exceeds a burstiness factor times an engineered number of messages of the certain type for a time interval, and, in response to determining that the number of messages exceeds the burstiness factor times the engineered number, rejecting additional messages of the certain type that arrive during the time interval.

13. The method of claim 1 wherein determining a loading status includes determining whether memory utilization at the SIP server exceeds a threshold and wherein rejecting SIP messages includes rejecting session initiating INVITE, REGISTER, and out-of-dialog requests in accordance with a memory utilization protection probability in response to determining that the memory utilization at the SIP server exceeds the threshold.

14. A system for providing overload control at a session initiation protocol (SIP) server, the system comprising:
a SIP server for sending and receiving SIP messages;
a SIP overload control module operatively associated with the SIP server for:
determining a loading status of a resource of the SIP server
computing a rejection probability based on the loading status of the resource of the SIP server; and
rejecting received SIP messages based on the rejection probability and the message type.

15. The system of claim 14 wherein the SIP overload control module is configured to determine the loading status of one of: memory, processing resources, internal network bandwidth, storage resources, processes or threads, and ports of the SIP server.

16. The system of claim 14 wherein the SIP overload control module is configured to compute the rejection probability in accordance with the following equation:
$${P}_{T}^{R} = \{ \begin{matrix}0 & {R}_{T} \leq {R}_{min} \\ \frac{{R}_{T} - {R}_{min}}{{R}_{max} - {R}_{min}} & {R}_{min} < {R}_{T} < {R}_{max} \\ 1 & {R}_{T} \geq {R}_{max}\end{matrix}$$
, where R_{T} is the loading status of the resource for a time interval T, Rₘᵢₙ is a first loading status threshold set based on an engineered traffic load of the SIP server, and Rₘₐₓ is a maximum loading status of the resource.

17. The system of claim 14 wherein the SIP overload control module is configured to set a loading status threshold dynamically based on a measured SIP message distribution and to use the loading status threshold to control the rejecting of the SIP messages.

18. The system of claim 14 wherein the SIP overload control module is configured to reject INVITE messages and out-of-dialog requests while allowing processing of in-dialog SIP messages.

19. The system of claim 14 wherein the message rejection probability comprises a weighted moving average of instantaneous rejection probabilities computed based on the loading status of the resource at different times.

20. The system of claim 14 wherein the SIP overload control module is configured to reject the SIP messages by sending SIP reply messages to senders of the rejected SIP messages.

21. The system of claim 20 wherein the SIP reply messages are sent without storing state information for the SIP reply messages at the SIP server.

22. The system of claim 20 wherein the SIP reply messages each include a retry-after header indicating that the senders should retry sending the rejected SIP messages after a specified time period.

23. The system of claim 14 wherein the SIP overload control module is further configured to count in-dialog SIP messages that arrive at the SIP server within a time interval, to compute a denial of service (DoS) protection rejection probability for each SIP message for which the count exceeds an engineered value and to reject or discard the SIP messages for which the count exceeds its respective engineered value messages in accordance with the DoS protection rejection probability.

24. The system of claim 23 wherein the SIP overload control module is configured to maintain separate counts for different types of in-dialog SIP messages and to compute separate DoS protection rejection probabilities for each type of the in-dialog SIP messages for which the count exceeds an engineered value for the respective in-dialog SIP message type.

25. The system of claim 14 wherein the SIP overload control module is configured to determine whether a number of the received SIP messages of a certain type exceeds a burstiness factor times an engineered number of message of the certain type for a time interval, and, in response to determining that the number of messages exceeds the burstiness factor times the engineered number, to reject additional messages of the certain type that arrive during the time interval.

26. The system of claim 14 wherein the SIP overload control module is configured to determine whether memory utilization at the SIP server exceeds a threshold and to reject session initiating INVITE, REGISTER, and out-of-dialog requests in accordance with a memory utilization rejection probability in response to determining that the memory utilization at the SIP server exceeds the threshold.

27. A computer readable medium having stored thereon executable instructions that when executed by the processor of a computer control the computer to perform steps comprising:
at a SIP server:
determining a loading status of a resource of the SIP server
computing a rejection based on the loading status of the resource of the SIP server; and
rejecting received SIP messages based on the types of the messages and the rejection probability.
